(19) United States
(12) Patent Application Publication
(10) Pub. No.: US 2006/0100129 A1
(43) Pub. Date: May 11, 2006

(54) Foam control agents for water-based printing inks and coatings

(76) Inventors: Sudhir Ananthachar, Parsippany, NJ (US); Andrew A. Romano, Sparta, NJ (US); Thomas J. Penny, Newton, NJ (US)

Correspondence Address: David L. Hedden;ASHLAND INC., P.O. Box 2219, Columbus, OH, 43216, US

(21) Appl. No.: 10/975,596

(22) Filed: Oct. 28, 2004

(51) Int. Cl. C09D 11/00

(52) U.S. Cl. 510/506; 106/31.13

(57) ABSTRACT

This invention relates to foam control agents for aqueous printing inks and coatings comprising a (a) certain siloxane polyalkyleneoxide copolymers, (b) N,N′-ethylene bisstearamide, and (c) polypropylene glycol.

### FIELD OF THE INVENTION

This invention relates to foam control agents for water-based printing inks and coatings comprising a (a) certain siloxane polyalkyleneoxide copolymers, (b) N,N′-ethylene bisstearamide, and (c) polypropylene glycol.

### BACKGROUND OF THE INVENTION

Printing inks generally include one or more vehicles and one or more colorants. The vehicle is typically a vegetable oil, fatty acid, resin, or polymer. The printing ink may also include other components such as organic solvents, water, and rheology modifiers. One of the problems with water-based printing inks, which are applied to various substrates using well-known printing techniques like flexography and gravure, is that they are inherently foamy.

The flexographic printing process is similar to letter press printing. It uses a printing surface made of a flexible material having a raised image. Ink is metered onto engraved metal or ceramic rollers fitted with a doctor blade, which wipes excess ink from the rollers. The ink is transferred from the rollers to the raised image on the flexible material. The ink on the raised image is then transferred to a substrate to form a print.

In the gravure process, an image is engraved into a cylinder in the form of cells, which become filled with ink. Printing is achieved by passing a substrate between the gravure cylinder and an impression roller under pressure.

Typically, foam control agents used in printing inks are formulated by dispersing hydrophobes in mineral oils, glycol ethers, and other carriers. Examples of hydrophobes used in foam control agents are silica, waxes, and silicones. These hydrophobes can be used individually or in various combinations and are well known to those skilled in the art.

Printing inks by nature are low viscosity materials, which are constantly subjected to re-circulation and shear forces. Therefore, they are much prone to foam than paints and coatings. Additionally, many conventional mineral oil based foam control agents react with the flexographic polymer plate and cause the plate to swell.

All citations referred to under this description of the “Related Art” and in the “Detailed Description of the Invention” are expressly incorporated by reference.

### SUMMARY OF THE INVENTION

This invention relates to foam control agents for water-based printing inks and coatings comprising:
(a) certain siloxane polyalkyleneoxide copolymers,
(b) N,N′-ethylene bisstearamide, and
(c) polypropylene glycol.

Although high molecular weight polypropylene glycols inhibit foam formations when used alone, they have poor efficacy. Furthermore, once foam is formed, the polypropylene glycol does not assist in breaking the foam. On the other hand, the foam control agents described herein, containing the combination of components, have a higher degree of efficacy than the conventional polypropylene glycol based and wax based foam control agents, and they assist in breaking the foam once it is generated.

### DETAILED DESCRIPTION OF THE INVENTION

The detailed description and examples will illustrate specific embodiments of the invention will enable one skilled in the art to practice the invention, including the best mode. It is contemplated that many equivalent embodiments of the invention will be operable besides these specifically disclosed.

The siloxanes used in the invention are siloxane polyalkyleneoxide copolymers represented by the following structural formula: 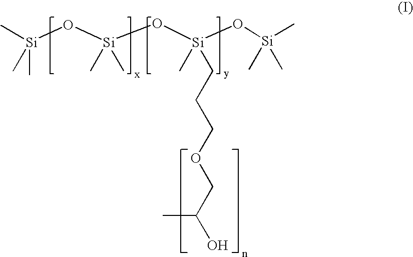
where x is from about 50 to about 80, y is from about 7 to about 9, the end groups are methyl, and n is from about 8 to 15, most preferably where x=about 65, y=about 8, and n=about 12.

The polypropylene glycol used has an average molecular weight ranging from 1000-3000, preferably from 2000-3000.

Optional components of the foam control agent include silicone oils, polyoxyethylene esters of oleic acid, sorbitan tristearate, waxes, surfactants, fatty acid esters, and end capped propylene oxide and/or butylene oxide polymers. The polyoxethylene esters of oleic acid are polyethylene glycol esters of nonionic and function as emulsifiers in the foam control agent. They are typically represented by the general formula:
R₁—(OCH₂CH₂)ₙ—R₂
where R₁ and R₂, which may be the same or different are —OH, laurate, palmitate, stearate, oleate or tallate, and n=1, 2, 3, 8,12, 30, or 40.

The amounts of the components used to make the foam control agent are as follows, where said weight percents are based upon the total weight of foam control agent:
(a) from 1 to 20 weight percent of siloxane, preferably 1 to 10, more preferably 2 to 7 weight percent;
(b) from 1 to 15 weight percent of ethylene bis stearamide, preferably 1 to 10, more preferably 2 to 8 weight percent; and
(c) from 65 to 98 weight percent of a polypropylene glycol, preferably 75 to 95, more preferably 80 to 90 weight percent.

When a silicone oil is used, it is typically used in an amount of 0.1 to 1.0 weight percent are based upon the total weight of foam control agent. When a polyoxyethylene ester of oleic acid is used in the foam control agent, it is typically used in an amount of 1.0 to 10.0 weight percent are based upon the total weight of foam control agent.

The foam control agents can be stored at temperatures of 0° C. to 40° C. for several months (typically up to six or even twelve months) before using them without a phase separation. They are typically mixed with inks in amounts of 0.01 to 2.0 part by weight based upon the weight of the latex emulsion, preferably from 0.2 to 0.8 part by weight.

The foam control agents are used in printing inks. The major components of a printing ink are a vehicle and a colorant. Typical vehicles include vegetable oils, fatty acids, resins, and polymers. Other components of the ink may include other components such as organic solvents, water, and rheology modifiers. Typically, the ink will contain the following amounts of various components:

| | |
|---|---|
| Pigment Dispersion (e.g. red, blue, yellow, black) | 30-45% |
| Film Forming polymer emulsion vehicle | 30-45% |
| Water | 1-10% |
| Polyethylene wax emulsions | 1-5% |
| Foam control agent | 0.2-1.0% |

Abbreviations

The following abbreviations are used:
DREWPLUS® 424 a polypropylene glycol based foam control foam control agent old by Drew Industrial of Ashland Specialty Chemical, a division of Ashland Inc.
DREWPLUS® W-4300 a foam control agent, as described in U.S. Pat. No. 6,579,908, and sold by Drew Industrial of Ashland Specialty Chemical, a division of Ashland Inc.
EBS Acrawax C-DF-1, ethylene bis stearaminde, manufactured by Lonza.
POEOA polyoxyethylene ester of oleic acid having a polyoxethylene molecular weight of 600.
PPP polypropylene glycol.
SCP a siloxane copolymer manufactured by OSI, as set forth in formula I, where x=65, y=8, and n=12.
SO silicone oil 1000 CS, manufactured by Dow Corning.

### EXAMPLE

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In this application, all units are in the metric system and all amounts and percentages are by weight, unless otherwise expressly indicated.

### Example 1

### Preparation of Foam Control Agent

A foam control agent was prepared by mixing the components set forth in Table I. Approximately one-half of the carrier was heated, then the one-half of the EBS was added. The second half of each component was added in the same order, followed by the SO. The POEOA was added next and finally the SC. The additions occurred under high agitation.

TABLE I

| Component | Amount (pbw) |
|---|---|
| PP | 89.0 |
| EBS | 4.85 |
| SO | 0.15 |
| PEOA | 4.0 |
| SC | 2.0 |
| Total | 100.0 |

The foam control agent was tested using the Waring blender test, which is described as follows:

### Waring Blender Test

First, 150 grams of ink base are added to a half-pint can. Then a pre-determined amount of foam control agent are added to a Cowles mixer and mixed for 15 minutes. This mixture is then transferred into the container of a Waring blender and the blender speed is set at maximum. The mixture is mixed for sixty seconds.

Thereafter, 100 ml of the mixture from the Waring blender is immediately taken for density measurement in g/ml. The density measurement is compared with the density of a Control that does not have a foam control agent and has not been shaken. A higher density indicates that there was less foaming when the composition was subjected to the shear forces of the Waring blender test.

The blended formulations were also aged for one week at a temperature of 50° C.

For comparison purposes, tests were also run on two commercially available foam control agents, namely DREWPLUS® W-4300 and L-424. The results are set forth in Table II.

TABLE II

| | | Initial | Density after one |
|---|---|---|---|
| Foam control agent | Concentration | Density | week aged @ 50° C. |
| Control | 0.5 | 1.03 | — |
| DREWPLUS W4300 | 0.5 | 0.78 | — |
| DREWPLUS L-424 | 0.5 | 0.65 | — |
| Example 1 | 0.5 | 0.92 | 0.92 |

The data in Table I indicate that the foam control agent of Example 1 was effective an foam control agent, as indicated by its density, and that its effectiveness was maintained even after one week.

We claim:

1. A foam control agent comprising comprising:
(a) a siloxane polyalkyleneoxide copolymer having the following chemical structure: 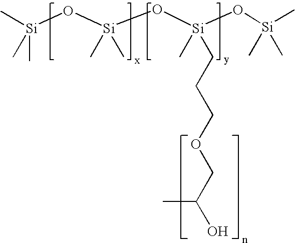
where x is from about 50 to about 80, y is from about 7 to about 9, and n is from about 8 to 15,
(b) N,N′-ethylene bisstearamide, and
(c) polypropylene glycol.

2. The foam control agent of claim 1 wherein the amounts of components are as follows:
(a) from 1 to 20 weight percent of a siloxane polyalkyleneoxide copolymer;
(b) from 1 to 15 weight percent of ethylene bis stearamide; and
(c) from 65 to 98 weight percent of a polypropylene glycol.

3. The foam control agent of claim 2, which further comprises a polyoxyethylene ester of oleic acid.

4. The foam control agent of claim 3, which further comprises a silicone oil.

5. The foam control agent of claim 4, which comprises:
(a) from 2 to 7 weight percent of siloxane polyalkyleneoxide copolymer;
(b) from 2 to 8 weight percent of ethylene bis stearamide;
(c) from 80 to 90 weight percent of polypropylene glycol;
(d) from 2 to 5 weight percent of a polyoxyethylene ester of oleic acid; and
(e) from 0.1 to 1.0 weight percent of a silicone oil.
where said weight percents are based upon the total weight of the foam control agent.

6. A printing ink comprising a vehicle, a colorant, and the foam foam control agent of claims 1, 2, 3, 4, or 5.
